(19) United States
(12) Patent Application Publication
(10) Pub. No.: US 2026/0105252 A1
(43) Pub. Date: Apr. 16, 2026

(54) METHODS FOR UTILIZING KNOWLEDGE GRAPHS TO PROVIDE REAL TIME AI INSIGHTS IN A COLLABORATIVE CHAT ENVIRONMENT AND SYSTEMS THEREOF

(71) Applicant: Jones Lang LaSalle IP, Inc., Chicago, IL (US)

(72) Inventors: Kai KANG, Shanghai (CN); Chenxi FENG, Chengdu (CN); Yao LIU, Chengdu (CN); Xing FAN, Shanghai (CN); Yi ZHOU, Chengdu (CN); Qingfen XU, Chengdu (CN)

(21) Appl. No.: 18/916,655

(22) Filed: Oct. 15, 2024

(51) Int. Cl. G06F 40/284; G06F 40/40

(52) U.S. Cl. CPC G06F 40/284; G06F 40/40

(57) ABSTRACT

A method, system, and non-transitory computer readable medium includes extracting key content from a question prompt using key information extraction and lexical analysis. The question prompt can be received from a client device. Next, the method can include generating an enriched question based on the question prompt and relevant node information and processing the enriched question with a machine learning model to generate an answer to the question prompt. The relevant node information can be based on relevant graph nodes obtained by matching the key content with nodes in a knowledge graph. Next, the method can include transmitting the answer to the question prompt received from the machine learning model to the client device.

This technology generally relates to generating a collaborative chat space tool and, more particularly, to methods for generating a collaborative chat tool with collective intelligence and insightful reports and devices thereof.

### BACKGROUND

Existing technologies for collaborative decision-making and report generation have significant limitations. For example, traditional processing methods often involve data collection and analysis, which can be time-consuming and prone to errors. These traditional processing methods also typically suffer from scheduling overhead, limited stakeholder engagement, and a lack of real-time data integration.

For instance, conventional tools based on these traditional processing methods may require stakeholders to participate in scheduled meetings, leading to delays and inefficiencies. Additionally, the absence of advanced data processing capabilities with these traditional processing methods means that insights are often derived from static data, which may not reflect the most current information. This can result in suboptimal decision-making and outdated reports. Furthermore, traditional processing methods lack the ability to dynamically incorporate diverse data sources and stakeholder inputs, making it challenging to generate comprehensive and accurate reports that address all concerns.

As a result, organizations struggle to make timely, data-driven decisions, ultimately impacting their operational efficiency and strategic outcomes. Thus, there is a need for a system with a collaborative chat space with collective intelligence for the generation of insightful reports.

### SUMMARY

A method that generates a collaborative chat space by extracting key content from a question prompt using key information extraction and lexical analysis. The question prompt can received from a client device. Next, the method can include generating an enriched question based on the question prompt and relevant node information and processing the enriched question with a machine learning model to generate an answer to the question prompt. The relevant node information can be based on relevant graph nodes obtained by matching the key content with nodes in a knowledge graph. Next, the method can include transmitting the answer to the question prompt received from the machine learning model to the client device.

A non-transitory computer readable medium having stored thereon instructions comprising machine executable code which when executed by at least one processor, causes the processor to extract key content from a question prompt using key information extraction and lexical analysis. The question prompt can received from a client device. Next, the processor can execute the executable code to generate an enriched question based on the question prompt and relevant node information and to process the enriched question with a machine learning model to generate an answer to the question prompt. The relevant node information can be based on relevant graph nodes obtained by matching the key content with nodes in a knowledge graph. Next, the processor can execute the executable code to transmit the answer to the question prompt received from the machine learning model to the client device.

A computing apparatus including at least one of configurable hardware logic configured to be capable of implementing or a processor coupled to a memory and configured to execute programmed instructions stored in the memory to extract key content from a question prompt using key information extraction and lexical analysis. The question prompt can received from a client device. Next, the processor can execute the programmed instructions to generate an enriched question based on the question prompt and relevant node information and to process the enriched question with a machine learning model to generate an answer to the question prompt. The relevant node information can be based on relevant graph nodes obtained by matching the key content with nodes in a knowledge graph. Next, the processor can execute the programmed instructions to transmit the answer to the question prompt received from the machine learning model to the client device.

This technology provides a number of advantages including providing a method, non-transitory computer readable medium, and apparatus that enable the generation of an effective collaborative chat space with collective intelligence that generates insightful data reports. This technology offers numerous advantages, including the creation of the collaborative chat space that facilitates the collection and generation of insightful data reports aligned with all stakeholders'concerns. By leveraging advanced technologies such as artificial intelligence and knowledge graphs, examples of this technology enable clients to ask questions at any time without pressure, thereby simplifying the decision-making process and promoting data-driven decisions. Examples of this technology also address the challenges of limited share of voices, scheduling overhead, and lack of data in collective decision-making by providing instant answers to stakeholders'concerns through the collaborative chat space. The integration of artificial intelligence enhances data analysis, summarization, and categorization, delivering valuable insights for decision-making processes in real time which otherwise would not be possible. Additionally, this technology strengthens a position of a company as a leader in technology products by offering faster decision execution, differentiation from competitors, and increased client satisfaction. This innovative solution not only improves decision quality and efficiency, but also mitigates risks, presenting growth opportunities for corporate occupiers. The ability to generate comprehensive and accurate reports in real-time, enriched with knowledge graphs, represents a transformative approach to decision-making that has not previously been available.

### BRIEF DESCRIPTION OF THE DRAWINGS

FIG. 1 is a block diagram of an example of an environment with a collaborative computing system configured to generate a collaborative chat space with collective intelligence for the generation of insightful reports;

FIG. 2A is a block diagram illustrating an example of an architecture of a collaborative computing system;

FIG. 2B is a block diagram illustrating an example of an architecture of a database;

FIG. 2C is a block diagram illustrating an example of an architecture of a client device;

FIG. 3 is an exemplary flowchart of an exemplary method of generating a collaborative chat space tool;

FIG. 4 is an exemplary interface illustrating an exemplary collaborative chat space home page with a new chat button to begin a new session which is generated using the collaborative computing system;

FIG. 5 is an exemplary interface illustrating an exemplary collaborative chat space with a new chat button, an instructional prompt and an input field generated using the collaborative computing system;

FIG. 6 is an exemplary interface illustrating an exemplary collaborative chat space with an interactive team members button and hover window with a list of team members generated using the collaborative computing system;

FIG. 7 is an exemplary interface illustrating an exemplary collaborative chat space with the instructional prompt filled with input from a user, where the exemplary collaborative chat space is generated using the collaborative computing system;

FIG. 8 is an exemplary interface illustrating an exemplary collaborative chat space with exemplary results in response to input from a user, where the exemplary collaborative chat space is generated using the collaborative computing system;

FIG. 9 is an exemplary interface illustrating an exemplary collaborative chat space with exemplary results in response to input from a user, where the exemplary collaborative chat space is generated using the collaborative computing system;

FIG. 10 is an exemplary interface illustrating an exemplary collaborative chat space with exemplary results in response to input from a user, where the exemplary collaborative chat space is generated using the collaborative computing system;

FIG. 11 is an exemplary interface illustrating an exemplary collaborative chat space with exemplary results in response to input from a user, where the exemplary collaborative chat space is generated using the collaborative computing system;

FIG. 12 is an exemplary interface illustrating an exemplary collaborative chat space with exemplary results in response to input from a user, where the exemplary collaborative chat space is generated using the collaborative computing system;

FIG. 13 is an exemplary interface illustrating an exemplary collaborative chat space with exemplary results in response to input from a user, where the exemplary collaborative chat space is generated using the collaborative computing system;

FIG. 14 is an exemplary interface illustrating an exemplary knowledge graph generated using the collaborative computing system;

FIG. 15 is an exemplary interface illustrating an exemplary collaborative chat space with an interactive generate survey button clicked by a user which generated a loading spinner, where the exemplary collaborative chat space is generated using the collaborative computing system;

FIG. 16 is an exemplary interface illustrating an exemplary interactive report, an export pdf button, a link button to generate a sharable link generated using the collaborative computing system;

FIG. 17 is an exemplary interface illustrating an exemplary interactive report, an export pdf button, a link button to generate a sharable link generated using the collaborative computing system;

FIG. 18 is an exemplary interface illustrating an exemplary interactive report, an export pdf button, a link button to generate a sharable link generated using the collaborative computing system;

FIG. 19 is an exemplary interface illustrating an exemplary interactive report, an export pdf button, a link button to generate a sharable link generated using the collaborative computing system;

FIG. 20 is an exemplary interface illustrating an exemplary interactive report, an export pdf button, a link button to generate a sharable link generated using the collaborative computing system;

FIG. 21 is an exemplary interface illustrating an exemplary interactive report, an export pdf button, a link button to generate a sharable link generated using the collaborative computing system; and

FIG. 22 is a flow diagram of a process of the collaborative computing system illustrating the data flow and interactions between data inputs and a machine learning model.

### DETAILED DESCRIPTION

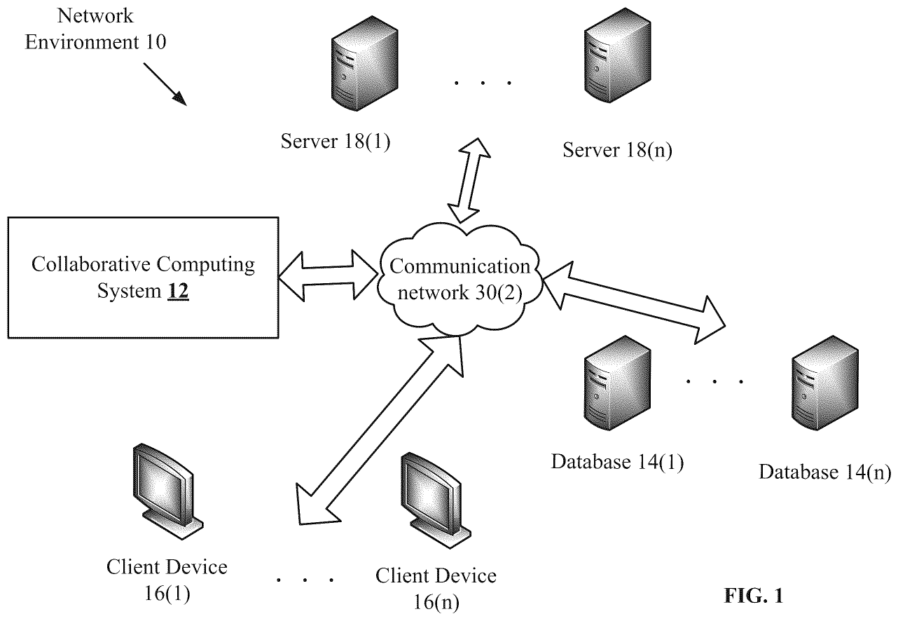

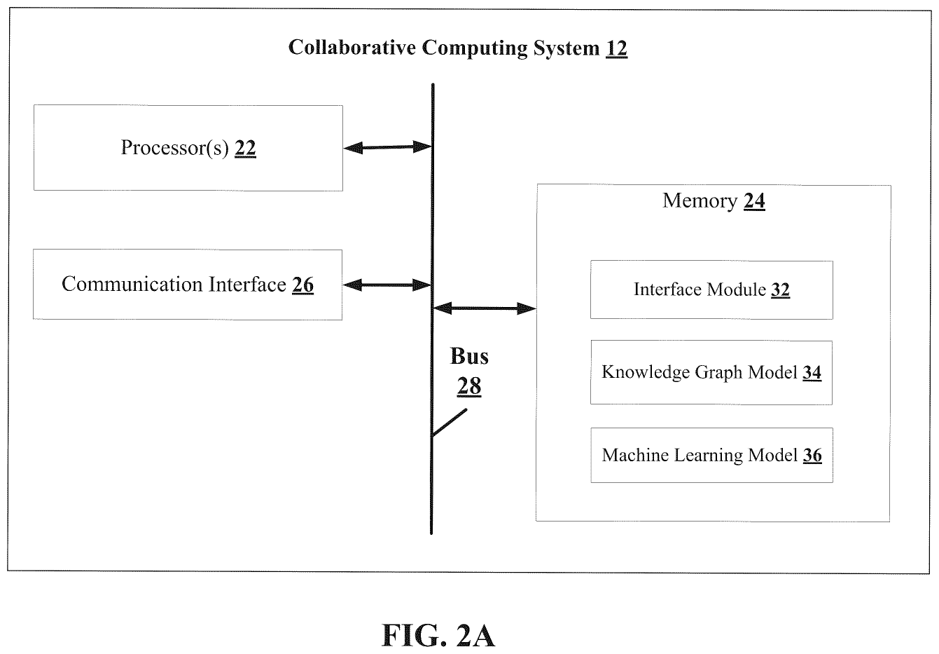

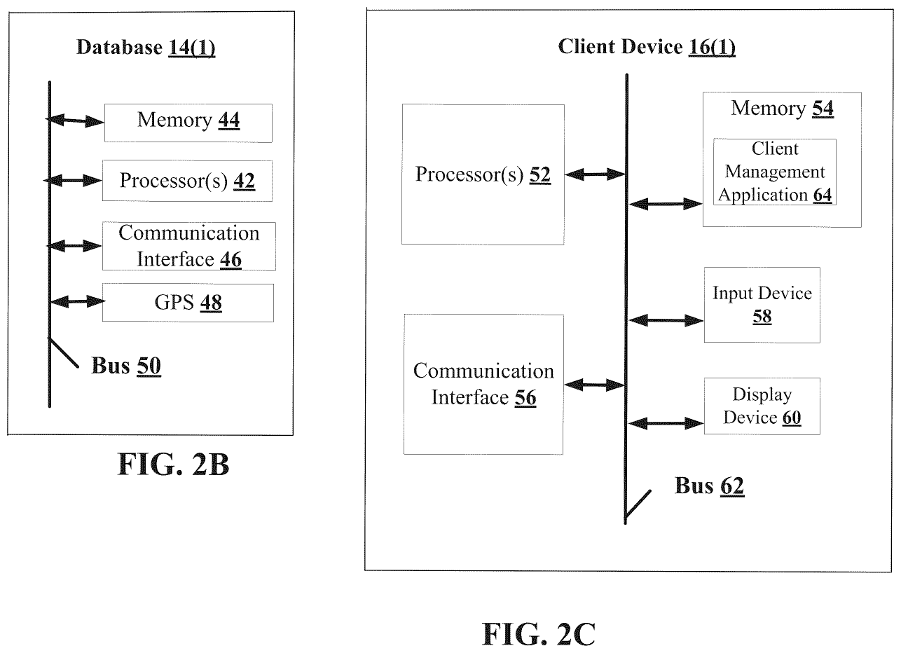

An environment 10 with an exemplary collaborative computing system 12 is shown in FIG. 1-2A. In this example, the environment 10 includes the collaborative computing system 12, a plurality of databases 14(1)-14(n), a plurality of client devices 16(1)-16(n), and a plurality of information servers 18(1)-18(n), although the environment may comprise other types and/or numbers of other systems, devices, components, and/or other elements in other configurations. This technology provides a number of advantages including providing systems, methods, and non-transitory computer readable media that enable the generation of a collaborative chat space with collective intelligence to generate insightful reports.

Referring to more specifically to FIG. 1-2A, in this example, the collaborative computing system 12 includes one or more processor(s) 22, a memory 24, and/or a communication interface 26, which are coupled together by a bus or other communication link 28, although the collaborative computing system 12 can include other types and/or numbers of elements in other configurations.

The processor(s) 22 of the collaborative computing system 12 may execute programmed instructions stored in the memory of the collaborative computing system 12 for any number of functions and other operations as illustrated and described by way of the examples herein. The processor(s) 22 of the collaborative computing system 12 may include one or more CPUs or general purpose processors with one or more processing cores, for example, although other types of processor(s) can also be used.

The memory 24 of the collaborative computing system 12 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s), can be used for the memory 24.

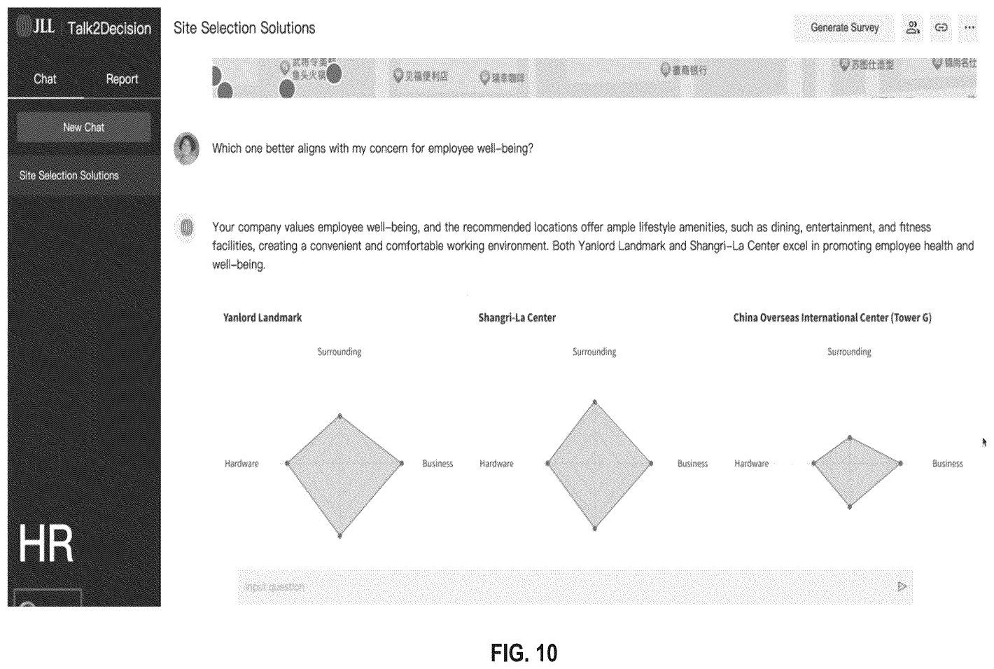

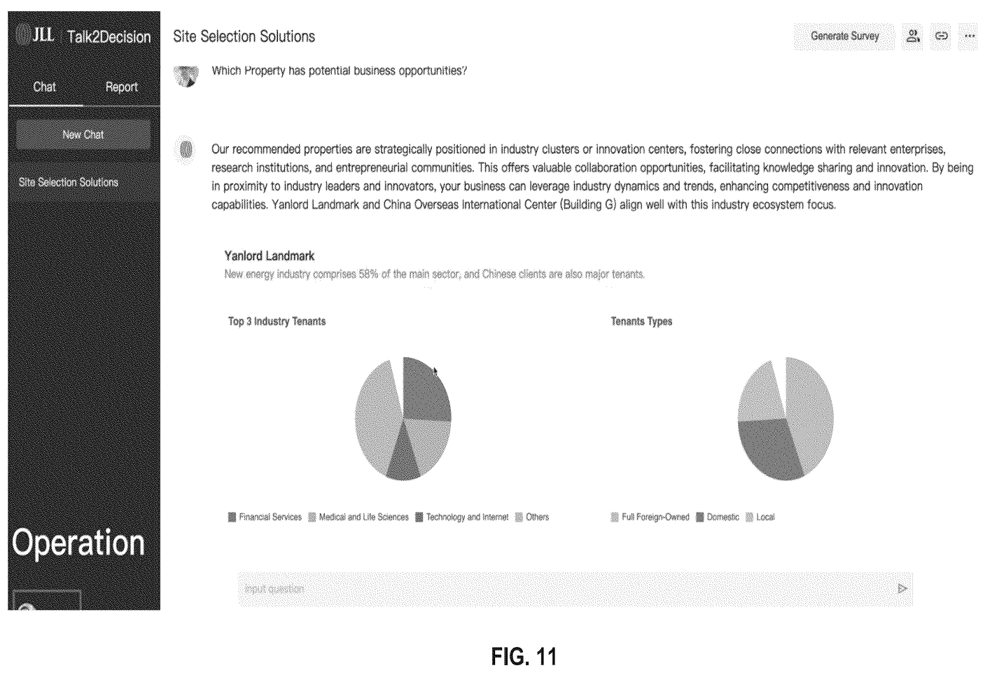

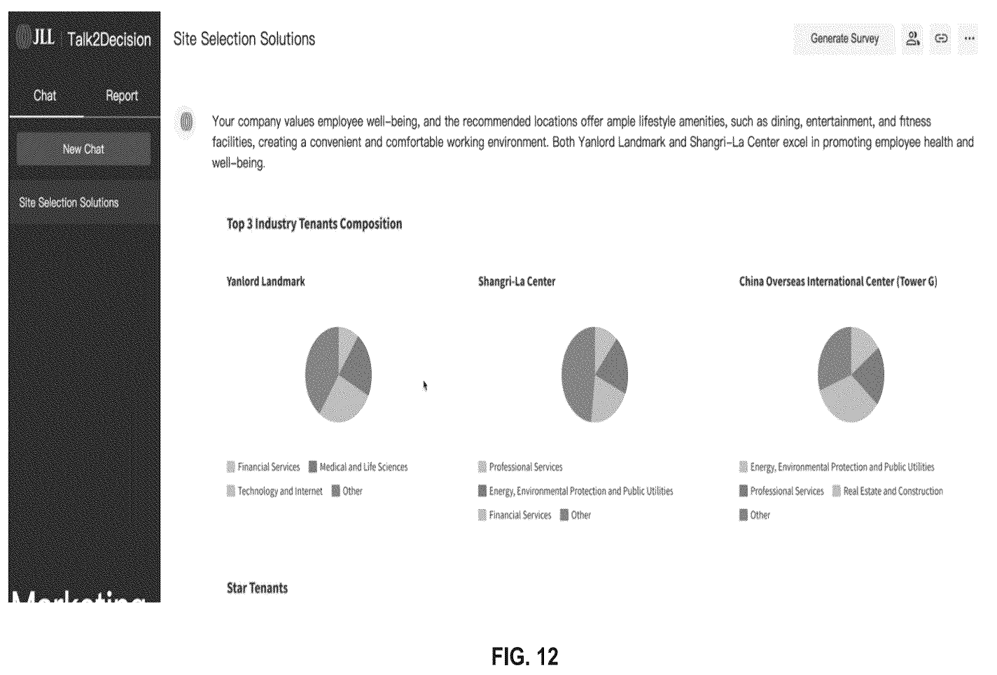

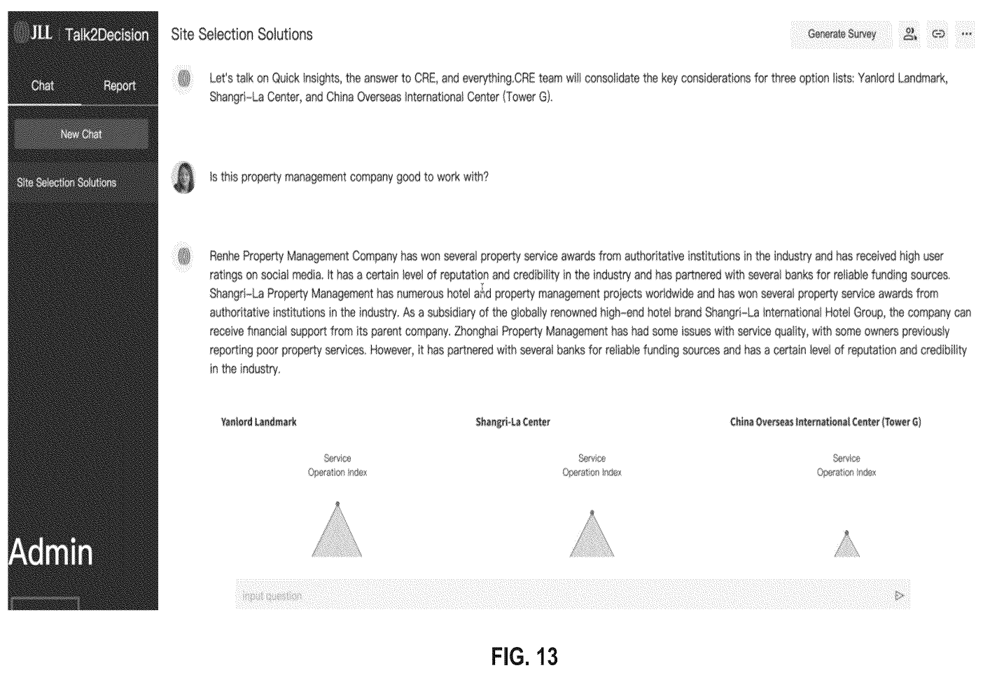

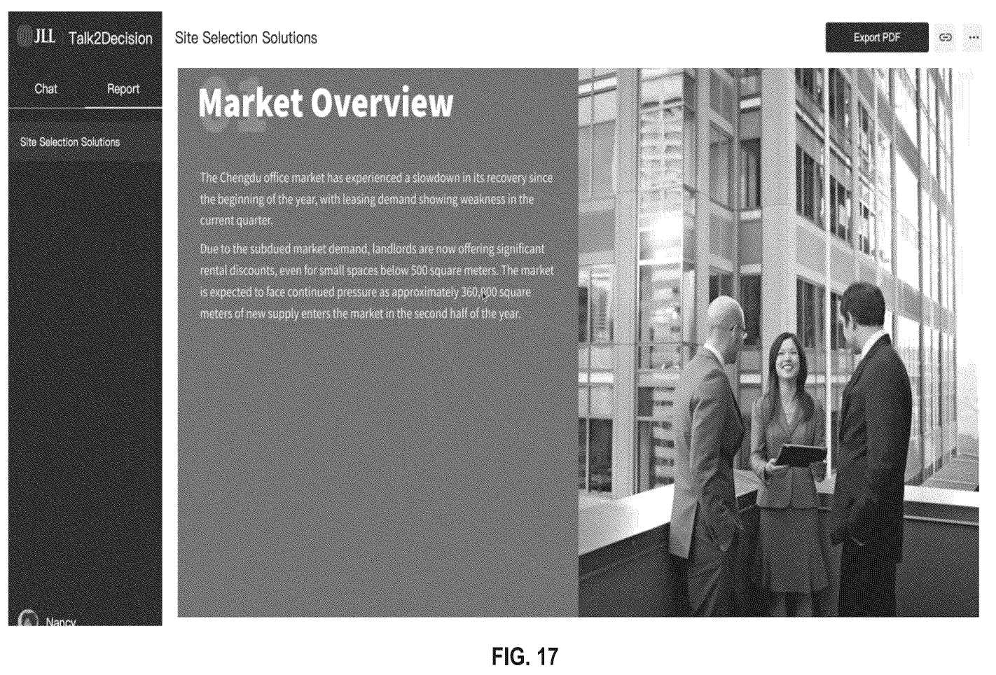

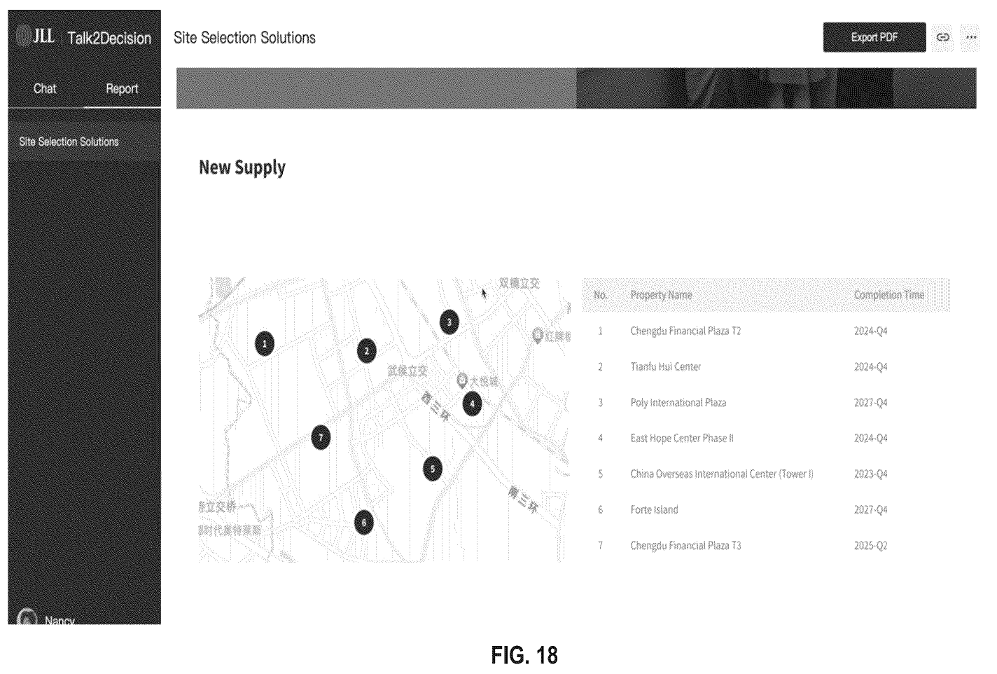

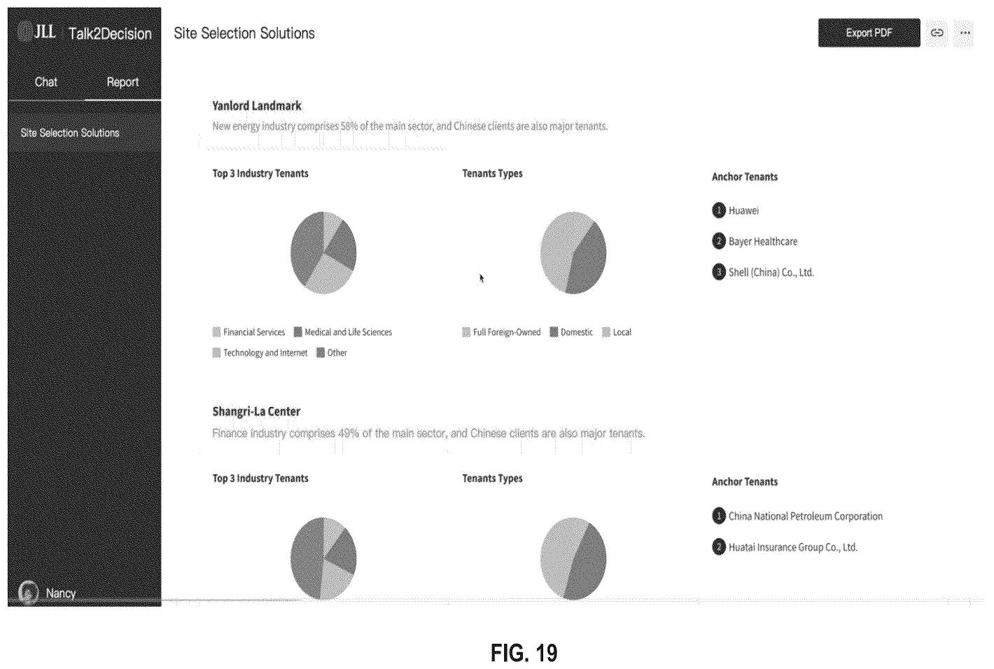

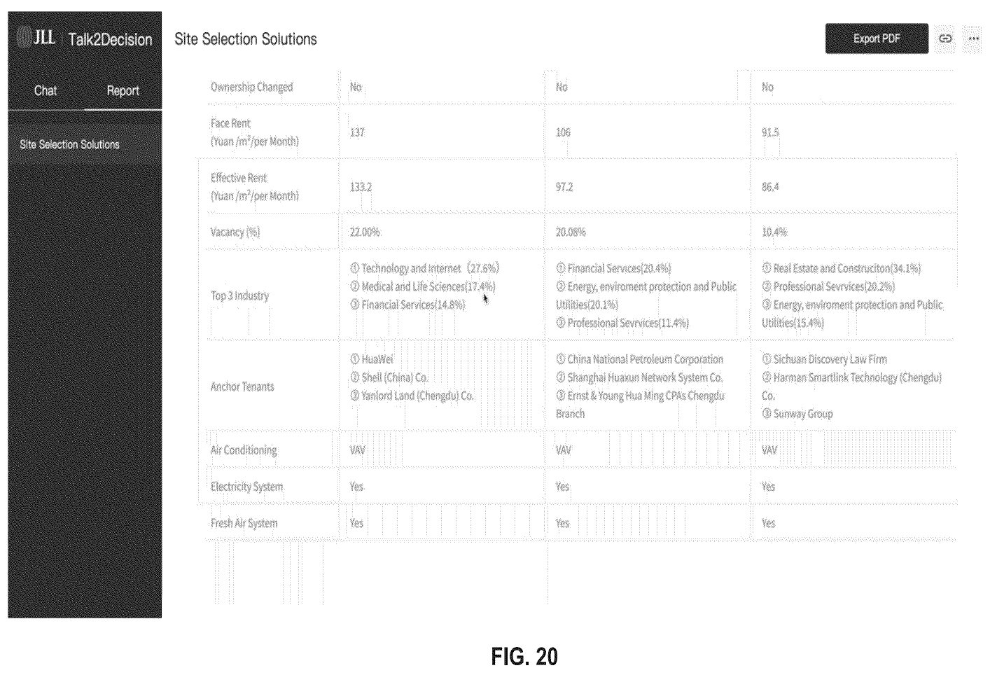

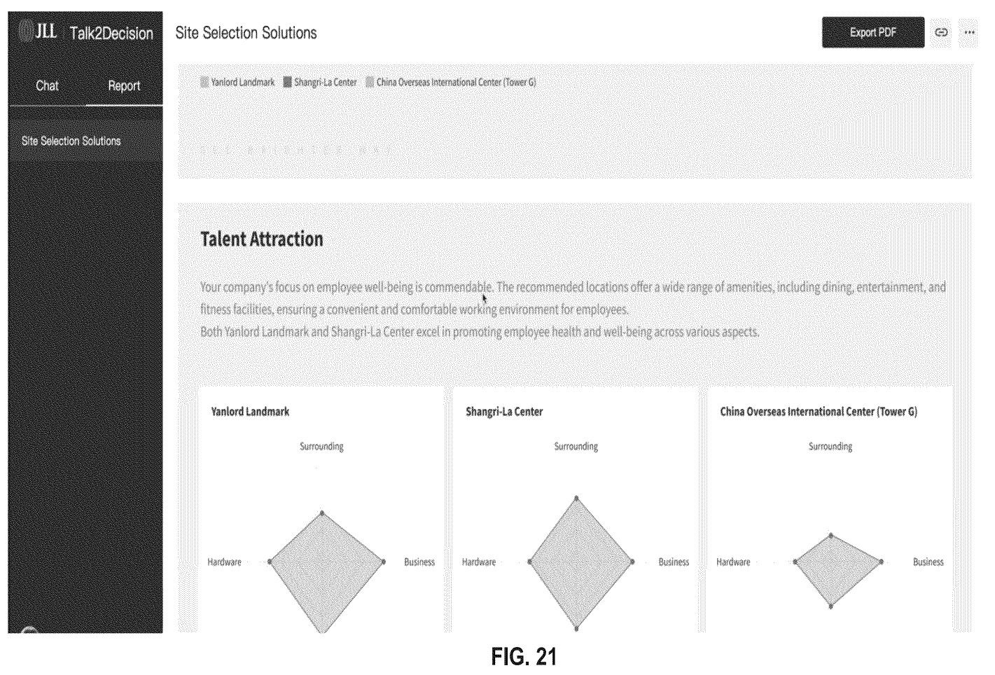

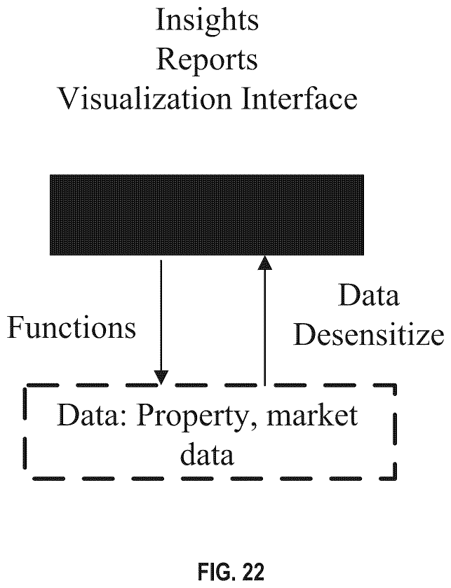

Accordingly, the memory 24 of the collaborative computing system 12 can store one or more applications that can include computer executable instructions that, when executed by the collaborative computing system 12, cause the collaborative computing system 12 to perform actions, such as to generate a collaborative chat space with one or more client devices 16(1)-16(n) and one or more servers 18(1)-18(n) in the environment 10, and other actions as described and illustrated in the examples below with reference to FIG. 1-22. The application(s) can be implemented as modules, programmed instructions, or components of other applications. Further, the application(s) can be implemented as operating system extensions, module, plugins, or the like.

Even further, the application(s) may be operative in a cloud-based computing environment. The application(s) can be executed within or as virtual machine(s) or virtual server(s) that may be managed in a cloud-based computing environment. Also, the application(s), and even the collaborative computing system 12 itself, may be located in virtual server(s) running in a cloud-based computing environment rather than being tied to one or more specific physical computing devices. Also, the application(s) may be running in one or more virtual machines (VMs) executing on the collaborative computing system 12. Additionally, in one or more embodiments of this technology, virtual machine(s) running on the collaborative computing system 12 may be managed or supervised by a hypervisor.

In this particular example, the memory 24 of the collaborative computing system 12 may include an interface module 32, a knowledge graph model module 34, and a machine learning model (MLM) 36 which may be executed as illustrated and described by way of the examples herein, although the memory 24 can for example include other types and/or numbers of modules, platforms, algorithms, programmed instructions, applications, or databases for implementing examples of this technology. In some embodiments, the interface module 32, the knowledge graph model module 34, and/or the MLM 36 can be one unified module that performs the functions of the interface module 32, the knowledge graph model module 34, and/or the MLM 36.

The interface module 32 may comprise executable instructions that are configured to generate visualizations or a plurality of graphical user interfaces using data, data structures, or output from the MLM 36, as illustrated and described in greater detail by way of the examples herein, although this module may have executable instructions that are configured to execute other types and/or functions or other operations to facilitate examples of this technology, such as transmitting the plurality of graphical user interfaces with generated visualizations to one of the client devices 16(1)-16(n) by way of example.

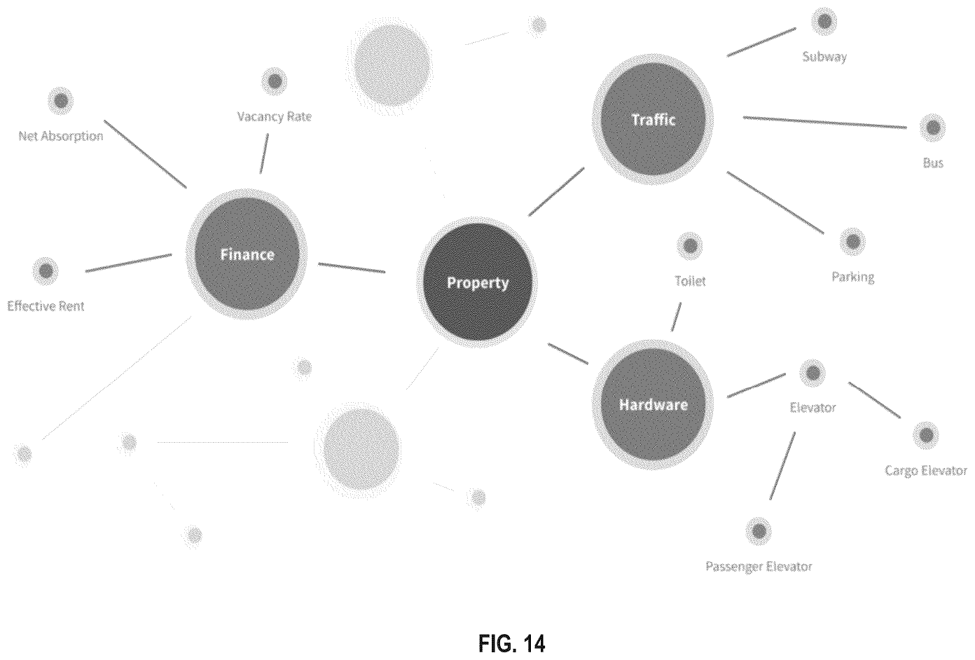

The knowledge graph module 34 may comprise executable instructions that are configured to generate knowledge graphs as illustrated in FIG. 14 using marketing data, property data, building data, data, or combinations thereof stored in the databases 14(1)-14(n) as illustrated and described in greater detail by way of the examples herein, although this module may have executable instructions that are configured to execute other types and/or functions or other operations to facilitate examples of this technology.

The MLM 36 may be a machine learning model 6. In one example, one or more developers may fine-tune a pre-trained MLM 36 with marketing data, property data, building data, or a real estate corpus to generate a fine-tuned MLM 36 for specific use cases. Although not illustrated, the plurality of servers 18(1)-18(n) may host and/or manage a plurality of MLMs which may be pre-trained general purpose MLMs or fine-tuned MLMs. The plurality of servers 18(1)-18(n) may be a cloud-based server or an on-premises server. The fine-tuned LLM 36 may be accessed using an application programming interface (API) for use in applications. In another example, the fine-tuned LLM 36 may be hosted by the plurality of servers 18(1)-18(n) and managed remotely by the collaborative computing system 12.

The MLM 36 can be a type of artificial intelligence-machine learning (AI/ML) model that is used to process natural language data for tasks such as natural language processing, text mining, text classification, machine translation, question-answering, response generation, or the like. The MLM 36 uses deep learning or neural networks to learn language features from large amounts of data. The MLM 36 is, for example, trained on a large dataset and then used to generate predictions or generate features from unseen data. The MLM 36 can be used to generate language features such as word embeddings, part-of-speech tags, named entity recognition, sentiment analysis, or the like. Unlike traditional rule-based NLP systems, the MLM 36 does not have to rely on pre-defined rules or templates to generate responses. Instead, the MLM 36 can use a probabilistic approach to language generation, where the MLM 36 can calculate the probability of each word in a response based on the patterns the MLM 36 learned from the training data.

The collaborative computing system 12 may contain programs that train, implement, store, receive, retrieve, and/or transmit one or more machine learning models 36. Machine learning models 36 may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models 36 may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The collaborative computing system 12 may be configured to adjust model parameters during training. Model parameters may include weights, coefficients, offsets, or the like. Training may be supervised or unsupervised.

The collaborative computing system 12 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The collaborative computing system 12 may be configured to optimize statistical models using known optimization techniques.

The collaborative computing system 12 using the MLMs 36 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may and indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The collaborative computing system 12 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some examples, the collaborative computing system 12 is configured to generate and/or train the MLM 36 to classify a dataset, consistent with disclosed examples.

The collaborative computing system 12 can be configured to generate and/or use the MLM 36 which includes programs (scripts, functions, algorithms) to configure data for visualizations and provide visualizations of datasets and data models. This may include programs to generate graphs and display graphs. The collaborative computing system 12 may include programs to generate histograms, scatter plots, time series, or the like. The collaborative computing system 12 may also be configured to display properties of data models and data model training results including, for example, architecture, loss functions, cross entropy, activation function values, embedding layer structure and/or outputs, convolution results, node outputs, or the like on the one or more of the client devices 16(1)-16(n).

The collaborative computing system 12 can also configure the MLMs 36 to generate and utilize knowledge graph models. Knowledge graphs are structured representations of information that capture relationships between data points, enabling enhanced data analysis and categorization. By extracting information from internal resources and external public materials, the collaborative computing system 12 can construct nodes and their associations to form a comprehensive knowledge graph. This graph can classify and summarize similar questions, providing more precise and enriched answers. The integration of knowledge graphs with the collaborative computing system 12 allows for the generation of more insightful reports and visualizations, enhancing the overall decision-making process by offering a deeper understanding of the data and its interconnections.

The communication interface 26 of the collaborative computing system 12 operatively couples and communicates between the collaborative computing system 12 and the one or more of databases 14(1)-14(n), the one or more of the client devices 16(1)-16(n), and the one or more servers 18(1)-18(n), although other types and/or numbers of connections and/or communication networks can be used.

While the collaborative computing system 12 is illustrated in this example as including a single device, the collaborative computing system 12 in other examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the collaborative computing system 12.

Additionally, one or more of the devices that together comprise the collaborative computing system 12 in other examples can be standalone devices or integrated with one or more other devices or apparatuses, such as in one of the server devices or in one or more computing devices for example. Moreover, one or more of the devices of the collaborative computing system 12 in these examples can be in a same or a different communication network including one or more public, private, or cloud networks, for example.

Although an exemplary collaborative computing system 12 is described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in this collaborative computing system 12, such as the collaborative computing system 12, for example, may be configured to operate as virtual instances on the same physical machine. In other words, by way of example one or more of the collaborative computing system 12 may operate on the same physical device rather than as separate devices communicating through communication network(s). Additionally, there may be more or fewer collaborative computing system 12 than illustrated in FIG. 1.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to conduct steps necessary to implement the methods of the examples of this technology that are described and illustrated herein.

Referring to FIGS. 1 and 2B, the plurality of databases 14(1)-14(n) may comprise a variety of different types and/or numbers of systems, devices, or other things in the environment 10, such as a variety of different marketing data, property data, building data, data, generated insight data, or combinations thereof by way of example only. In this example, the collaborative computing system 12 has a table, a data structure, or other manner organizing the marketing data, property data, building data, data, generated insight data, or combinations thereof by way of example, although other manners for categorizing and organizing the data can be used. In this example, each of the databases 14(1)-14(n) at least have the same following structure and operation as shown in the example of the database 14(1) shown in FIG. 2B, although databases 14(1)-14(n) with other types and/or numbers of other systems, devices, components, and/or other elements may be used. Additionally, in this example, the database 14(1) has one or more processors 42, a memory 44, a communication interface, and a global positioning system (GPS) device 48 which are coupled together by a bus or other communication link 50, although each database of data could have other types and/or numbers of systems, devices, components and/or other elements in other configurations.

Referring to FIGS. 1 and 2C, the plurality of client devices 16(1)-16(n) in this example includes any type of computing device that can participate in the generation of a collaborative chat space tool using data structures, marketing data, property data, building data, reports, and an interface to generate visualizations in an environment 10 with a client management application 64, such as mobile computing devices, desktop computing devices, laptop computing devices, tablet computing devices, virtual machines (including cloud-based computers), or the like. In this example, each of the client devices 16(1)-16(n) at least have the same following structure and operation as shown in the example of the client device 16(1) shown in FIG. 2C, although client devices with other types and/or numbers of other systems, devices, components, and/or other elements may be used. Additionally in this example, the client device 16(1) includes one or more processor 52, a memory 54, a communication interface 56, an input device 58, and a display device 60, which are coupled together by a bus or other communication link 62, types and/or numbers of systems, devices, components, or other elements in other configurations. Additionally, in this example the memory 54 includes a client management application 64 which enables the client 16(1) to interact with the collaborative computing system 12 and one or more of the databases 14(1)-14(n) as illustrated and described by way of the examples herein, although the memory 54 can include other programmed instructions, modules, applications, or other data for example.

The plurality of servers 18(1)-18(n) in this example includes one or more processors, a memory, and a communication interface, which are coupled together by a bus or other communication link, although other numbers and/or types of network devices could be used. In this example, the servers 18(1)-18(n) can be located at different locations and may each process requests received from the collaborative computing system 12 and/or the client devices 16(1)-16(n) via the communication network(s) 20. Various data and other applications may be operating on the collaborative computing system 12 and transmitting data (e.g., files or Web pages) to the collaborative computing system 12 and/or the client devices 16(1)-16(n). The servers 18(1)-18(n) may be hardware or software or may represent a system with multiple servers in a pool, which may include internal or external networks.

An exemplary method for generating a collaborative chat space in the environment 10 with the collaborative computing system 12 and one or more of the client devices 16(1)-16(n) will now be described with reference to FIG. 1-22.

### Data Preparation

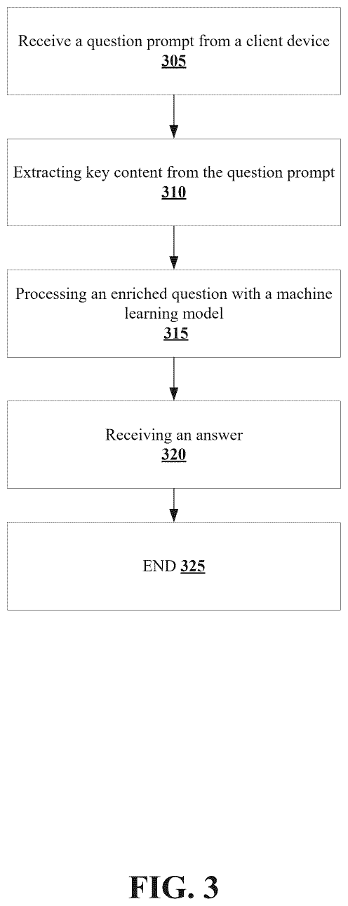

Referring more specifically to FIG. 3, the collaborative computing system 12 can prepare for the collaborative chat space using data. In a non-limiting example, the data can include client data such as employee addresses, team members, project details, organizational charts, contact information, and meeting schedules, other client data known in the art, or combinations thereof. The data can further include shortlists, market data, macro data, news data, financial reports, competitive analysis, industry trends, and regulatory updates, other data known in the art, or combinations thereof.

A shortlist can be a condensed list of selected items or candidates chosen from a larger pool for further consideration or action. Shortlists can serve various purposes across different contexts, such as recruitment (a list of candidates selected for further interviews), procurement (a list of pre-qualified suppliers or vendors), project management (a list of prioritized projects or initiatives), and real estate (a list of properties meeting specific criteria for purchase or lease). The shortlist could also include a list of prioritized options or recommendations generated based on data analysis and stakeholder inputs.

Using shortlists in the collaborative computing system 12 to prepare the collaborative chat space would be highly beneficial. Shortlists can streamline the decision-making process by focusing on the most relevant and high-priority items, thereby reducing the complexity and volume of data that users need to sift through. This targeted approach allows for more efficient and effective communication among stakeholders, as it highlights the key options and recommendations that require attention. Additionally, shortlists can facilitate quicker consensus and alignment among team members by presenting a curated set of choices that have already been vetted and prioritized based on data analysis and stakeholder inputs. This not only enhances the user experience but also improves the overall efficiency and productivity of the collaborative process.

### Question Prompts

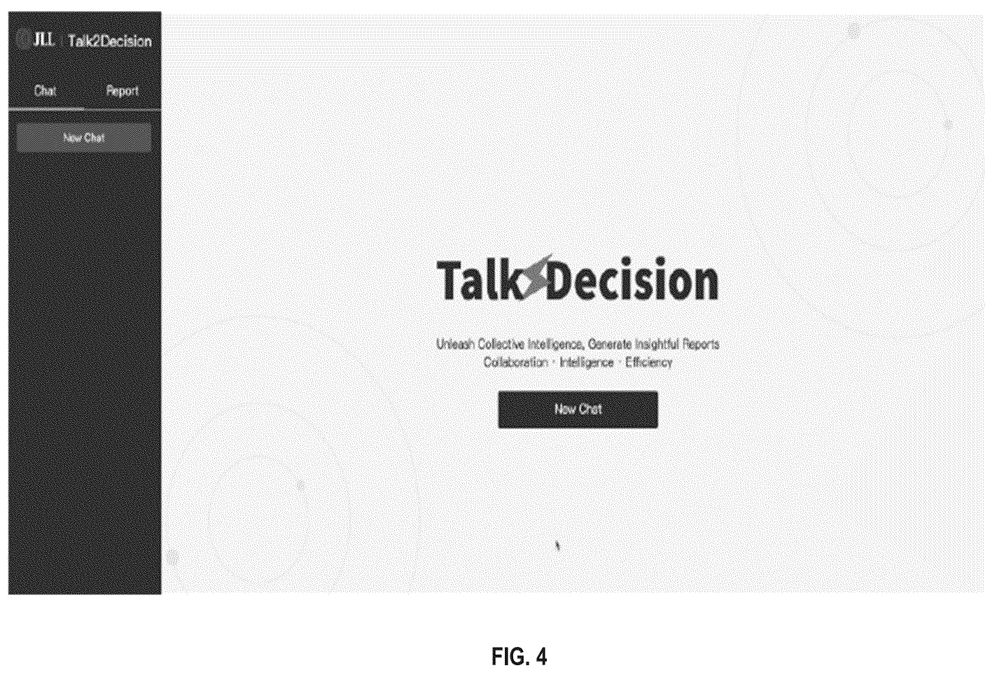

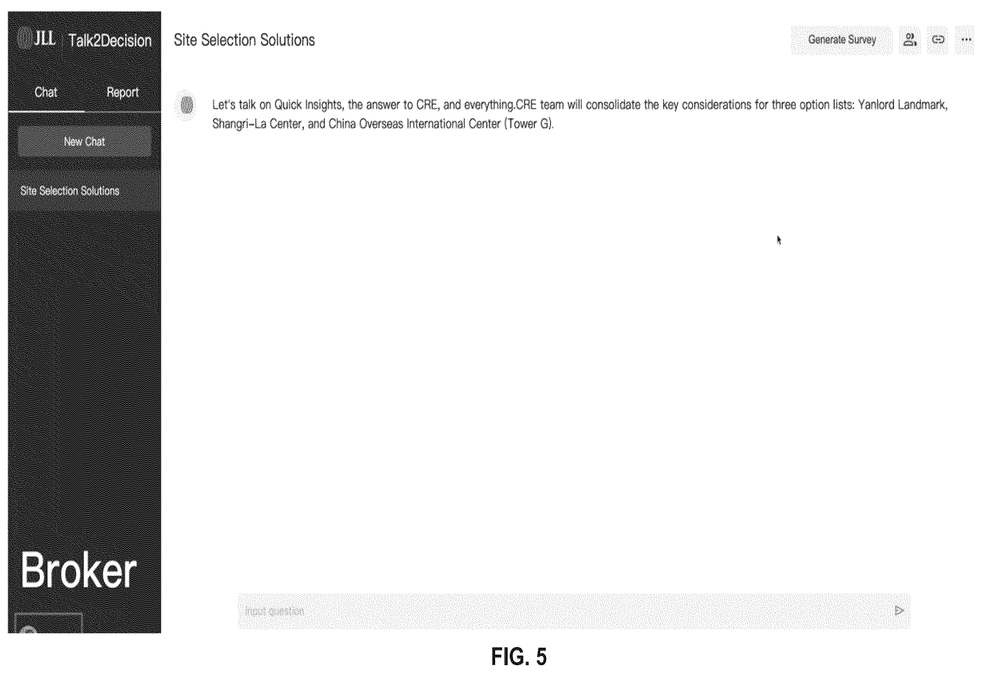

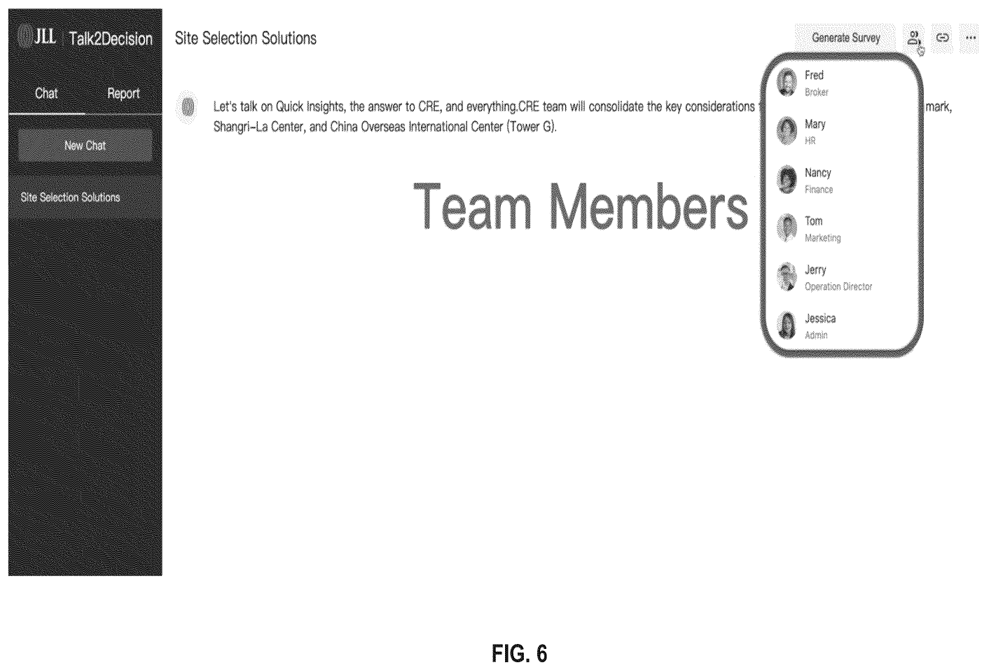

As illustrated in FIG. 4, the collaborative computing system 12 can generate a graphical user interface with interactive objects (e.g., a new chat button) that are configured to allow the initiation of the process in FIG. 3. Then, as illustrated in FIG. 5, the collaborative computing system 12, using the interface module 32, can generate a graphical user interface comprising a chatbot configured to receive one or more question prompts and provide one or more answers to the one or more question prompts. A chatbot is an artificial intelligence (AI) application (e.g., MLM 36) designed to simulate human conversation, allowing users to interact with digital systems through text or voice inputs. The collaborative computing system 12 can transmit the graphical user interface to one or more users at a respective one or more client devices at the client devices 16(1)-16(n) (as illustrated in FIG. 6). The graphical user interface comprising the chatbot 36 can assist users in a collaborative chat space by collecting concerns or inquiries, generating responses to the inquiries, or producing an insightful report to align the concerns of one or more users. The collaborative chat space thus acts as a centralized platform where stakeholders can communicate, share information, and receive data-driven insights, facilitating more effective and coordinated decision-making processes.

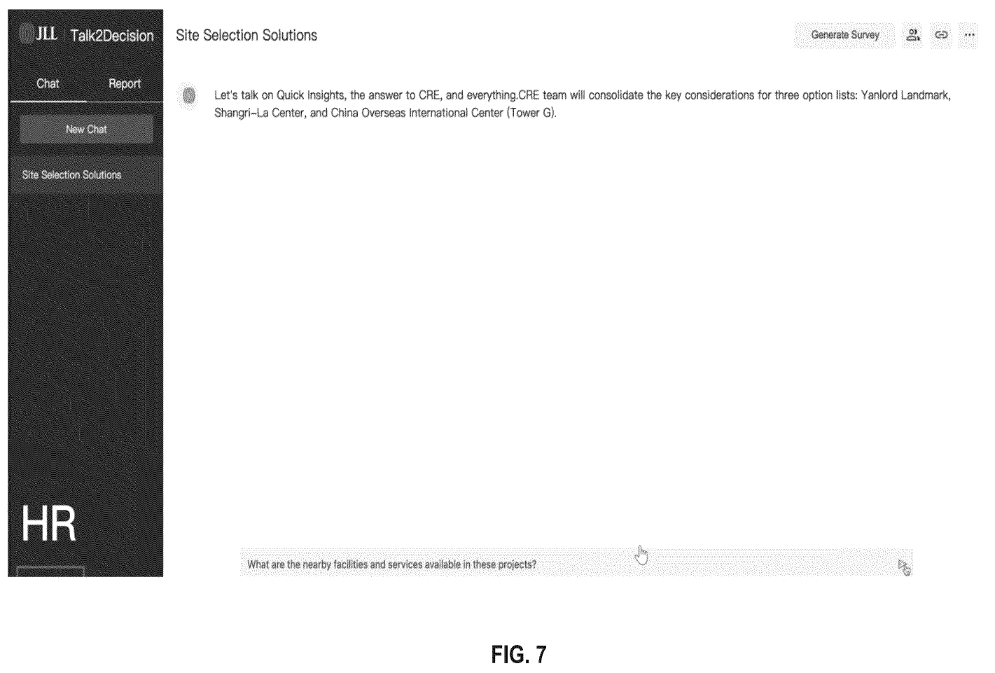

As illustrated in FIG. 7, in step 305, the collaborative computing system 12, via an input field in the graphical user interface, can receive a question prompt from a client device at one of the client devices 16(1)-16(n). The input field is related to the chatbot 36 as it serves as the medium through which users can enter their question prompts or inquiries. The chatbot 36 then processes these inputs as question prompts to generate appropriate responses as outlined below. The question prompt can further comprise two or more question prompts. The one or more users at a respective one or more client devices at the client devices 16(1)-16(n) can send two or more question prompts (e.g., concerns or inquiries) to the collaborative computing system 12 to receive instant answers using the method outlined in FIG. 3. Allowing one or more users to send two or more question prompts enables a collaborative chat space by facilitating real-time interaction and information exchange among multiple users (such as stakeholders), thereby enhancing collective problem-solving and decision-making.

### Machine Learning Model

### Enriched Questions

In step 310, the collaborative computing system 12 can generate an enriched question by extracting key content from the question prompt using key information extraction and lexical analysis. Key information extraction involves identifying and isolating the most relevant pieces of information from the question prompt, such as keywords, entities, and relationships. Lexical analysis, on the other hand, involves examining the structure and meaning of the text to understand the context and semantics of the question prompt. By combining these techniques, the collaborative computing system 12 can accurately interpret the user's input, ensuring that the chatbot 36 (herein referred to as MLM 36) provides precise and relevant responses. This process enhances the overall effectiveness of the collaborative chat space by enabling more accurate and insightful interactions.

The collaborative computing system 12 can then generate the enriched question using the question prompt and relevant node information. The relevant node information can be based on relevant graph nodes by matching the key content with nodes in a knowledge graph (generated using the knowledge graph module 34). An exemplary knowledge graph is illustrated in FIG. 14. The collaborative computing system 12 first can identify the key content from the question prompt, such as specific terms or phrases that represent the core of the inquiry as outlined above. These key terms are then matched with corresponding nodes in the knowledge graph, which represent various concepts, entities, or data points. By associating the question prompt with the appropriate nodes and their respective branch nodes, the collaborative computing system 12 can provide a more comprehensive and enriched response. This enriched question, which includes both the original question prompt and the relevant node information, is then used to query the machine learning model 36. This approach ensures that the responses generated are not only accurate but also contextually relevant, thereby enhancing the decision-making process for the users.

### Knowledge Graphs

The collaborative computing system 12, using the knowledge graph module 34, can generate the knowledge graph (as illustrated in FIG. 14) by extracting key points and relationships between the key points from internal resources and external public materials/resources. The internal resources and external public materials/resources can include research reports, articles, corpuses, and external economic policies. The collaborative computing system 12 can use natural language processing (NLP) techniques to identify and extract key points, such as important terms, entities, and concepts, from these resources. Relationships between these key points are identified by analyzing the context in which they appear, such as co-occurrence in the same sentence or paragraph, or through explicit relational phrases. The collaborative computing system 12 can generate nodes and associations for each of the nodes based on the key points and respective relationships. These nodes and associations can be refined through manual verification from the user, where users review and confirm the accuracy of the extracted information and relationships, making adjustments as necessary to ensure the knowledge graph's reliability and relevance. The collaborative computing system 12 can also classify question prompts using the knowledge graph, as a user utilizes the system 12 to allow for the categorization and summarization of future question prompts. This classification process enables the collaborative computing system 12 to group similar questions together, providing more organized and efficient responses, and enhancing the overall user experience by ensuring that the information provided is both comprehensive and contextually appropriate.

In a non-limiting example, if a question prompt includes employee well-being, the collaborative computing system 12 can associate the question prompt with nodes related to building infrastructure, transportation, and surrounding amenities. Any associated nodes may have their own respective branch nodes, such as banks, restaurants, entertainment facilities, and other topics known in the art. By using the associated nodes, the collaborative computing system 12 can establish a more comprehensive and enriched knowledge graph to provide users with more comprehensive and accurate information in response to their question prompts. This enriched knowledge graph allows the collaborative computing system 12 to draw connections between various aspects of employee well-being and related factors, ensuring that the responses are not only relevant but also holistic. For instance, understanding that employee well-being is influenced by factors such as commute times, access to amenities, and workplace environment, the collaborative computing system 12 can provide detailed insights and recommendations that address these interconnected elements. This approach ensures that users receive a well-rounded perspective, enabling them to make more informed decisions that take into account the multifaceted nature of the issues at hand.

By leveraging the depth and breadth of the knowledge graph, the collaborative computing system 12 enhances its ability to deliver precise, contextually rich, and actionable information to its users. Using the knowledge graph can enable the collaborative computing system 12 to enhance data analysis, summarization, and categorization of question prompts by using additional relevant details to make question prompts more precise and enriched. This enhanced data analysis can provide valuable insights for decision making processes. Additionally, the knowledge graph facilitates predictive analytics by identifying patterns and trends within the data, allowing users to anticipate future needs and challenges. It also supports continuous learning and improvement, as the collaborative computing system 12 updates and refines the knowledge graph based on new information and user feedback. This dynamic capability ensures that the collaborative computing system 12 remains current and effective in addressing evolving user requirements. Overall, the knowledge graph significantly boosts the ability of the collaborative computing system 12 to offer comprehensive, timely, and relevant solutions, thereby improving the overall user experience and decision-making efficacy.

### Function Invocation

In step 315, the collaborative computing system 12 can process the enriched question with a machine learning model 36 to generate an answer to the question prompt. The machine learning model 36, in a non-limiting example, can be OpenAI. OpenAI is an artificial intelligence research organization that develops advanced AI models, including natural language processing systems like GPT-3, which are capable of understanding and generating human-like text. The collaborative computing system 12 can utilize an internal API for user-browser communication, ensuring seamless interaction between the user and the system. Additionally, the collaborative computing system 12 can leverage an external API from OpenAI or Microsoft Azure for ChatGPT-related functions, enabling advanced natural language processing capabilities. These APIs facilitate the integration of enriched questions with the machine learning model 36, allowing for more accurate and contextually relevant responses to user inquiries.

The collaborative computing system 12 can then receive a response based on the enhanced question. The response from the machine learning model 36 can include a recommendation on whether a function invocation of an API at one of the servers 18(1)-18(n) is needed to integrate data from an internal system with the enriched question. The collaborative computing system 12 can receive this function invocation recommendation from the machine learning model 36. The machine learning model 36 can analyze question prompts to determine if a function invocation is necessary and, when recommended, provide the function invocation with corresponding parameters in the response.

Function invocations can be predetermined functions or custom functions that allow the collaborative computing system 12 to query existing systems based on the of question prompts. Examples of specific systems include customer relationship management (CRM) systems, enterprise resource planning (ERP) systems, and human resources (HR) systems. By accessing these systems, the collaborative computing system 12 can retrieve relevant data such as customer profiles, project statuses, and employee records. This integration of data from internal systems with the machine learning model 36 (e.g., OpenAI) enhances the user experience by providing high-quality solutions. By accessing specific systems as needed, the collaborative computing system 12 can deliver more accurate and contextually relevant responses. For instance, if a user inquires about the status of a project, the collaborative computing system 12 can pull real-time data from the ERP system to provide an up-to-date response. Similarly, if a user asks about employee well-being, the collaborative computing system 12 can access HR records to offer insights based on current employee data. This capability improves the overall effectiveness and efficiency of the collaborative computing system 12, ensuring that users receive precise and actionable information.

The machine learning model 36 can be configured to retrieve API interface information from existing systems, such as CRM, ERP, or HR systems. This retrieval process involves accessing the existing system's API documentation, which outlines the available functions, endpoints, and required parameters. The machine learning model 36 can then define input and output parameters for functions based on this API interface information. Input parameters are typically defined by identifying the necessary data required to execute a function. Output parameters are determined by specifying the type of data that the function will return.

In a non-limiting example, if the machine learning model 36 retrieves an API interface with a function to query project basic information, an input parameter can be a project name, and an output parameter can include various project details such as basic information, hardware information, tenant information, and other information known in the art. The input parameter, the project name, could have been determined by identifying the key piece of information needed to uniquely identify and retrieve the relevant project data. The output parameters, such as basic information, hardware information, and tenant information, could have been determined by analyzing the types of data that are typically associated with a project and are useful for the user. When the collaborative computing system 12 later invokes the function to query project basic information, the collaborative computing system 12 can use the input parameter with the project name.

Thus, as outlined above, in response to determining the machine learning model 36 recommends the function invocation, the machine learning model 36 can provide the function invocation with the corresponding parameters to the API at one of the servers 18(1)-18(n) and receive, in response to the API call, a response to the function invocation for the collaborative computing system 12. Then, the collaborative computing system 12 can provide the enriched question including the question prompt and the response to the function invocation back to the machine learning model 36 to receive an answer.

In step 320, the collaborative computing system 12 can then receive an answer. The machine learning model 36 generates this answer by combining the original question prompt with the response from the function invocation. The machine learning model 36 first converts the returned structured data from the function invocation into coherent textual data. This conversion process involves transforming the structured data into a readable format, such as sentences or paragraphs, that can be easily understood by the user. The machine learning model 36 then integrates this textual data with the context provided by the original question prompt. By synthesizing the information from both sources, the machine learning model 36 can generate a comprehensive and contextually relevant response. This ensures that the final answer is accurate, coherent, and actionable, providing the user with a well-rounded and insightful solution to their inquiry.

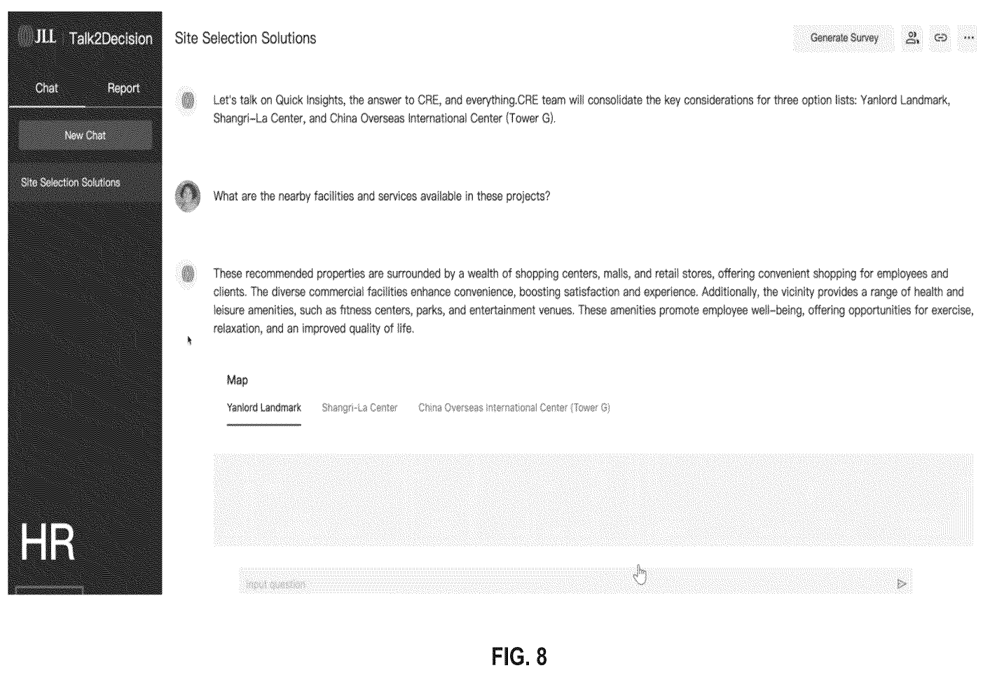

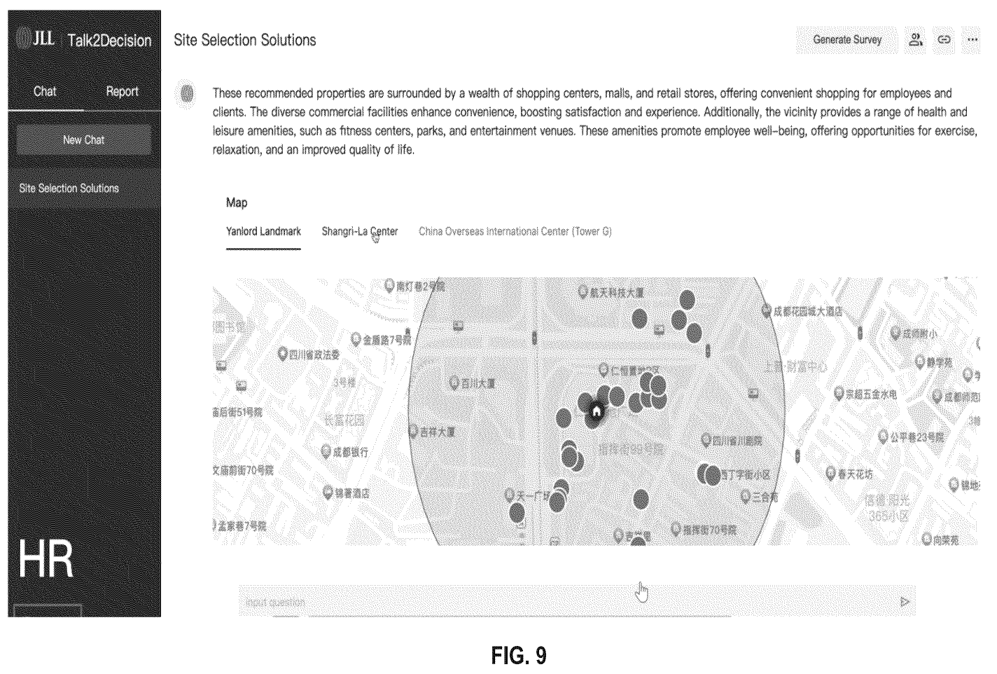

As illustrated in FIG. 8-13, the collaborative computing system 12, using the interface module 32, can transmit a modified graphical user interface including the answer to the client device at one of the client devices 16(1)-16(n). This modified graphical user interface can offer clarity to the one or more users by presenting the answer in a clear and organized manner. The modified graphical user interface can include data visualizations generated using the interface module 32 as illustrated in FIG. 9-13—such as interactive maps, which allow users to explore geographical data dynamically; radar charts, which display multivariate data in a way that highlights performance across different metrics; industry layouts, which provide visual representations of market structures and relationships; and customer profiling, which visualizes customer data to identify trends and patterns. Other examples of visualizations include bar charts, pie charts, heat maps, and timelines, all of which can help users better understand the data and insights provided in the answer.

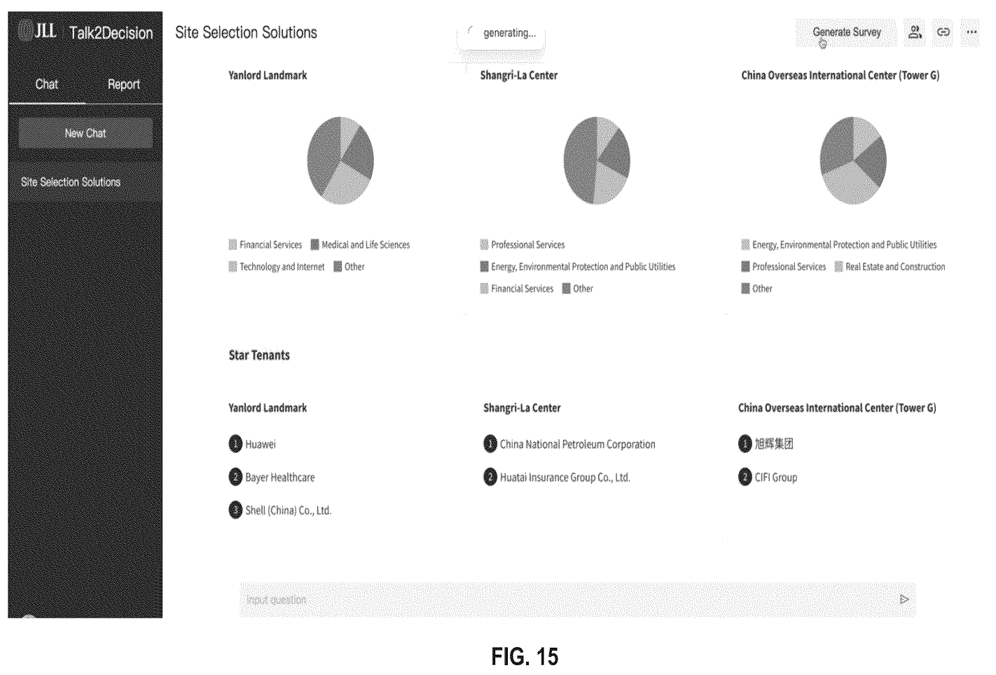

As illustrated in FIG. 15, in a non-limiting example, the collaborative computing system 12 can receive a request for a report. The report is a comprehensive document generated to address two or more question prompts from one or more users, summarizing the best solutions to the two or more question prompts. The collaborative computing system 12 can generate the report by classifying the two or more question prompts into groups based on the type of question prompts. For instance, prompts related to project management, employee well-being, and customer feedback can be grouped accordingly. The one or more answers to the two or more question prompts can be enhanced using the knowledge graph based on these groupings. By leveraging the knowledge graph, the collaborative computing system 12 can provide more detailed and contextually relevant answers, ensuring that the report offers comprehensive insights. This approach allows the collaborative computing system 12 to deliver enhanced answers by using the grouped prompts to identify common themes and provide more targeted recommendations.

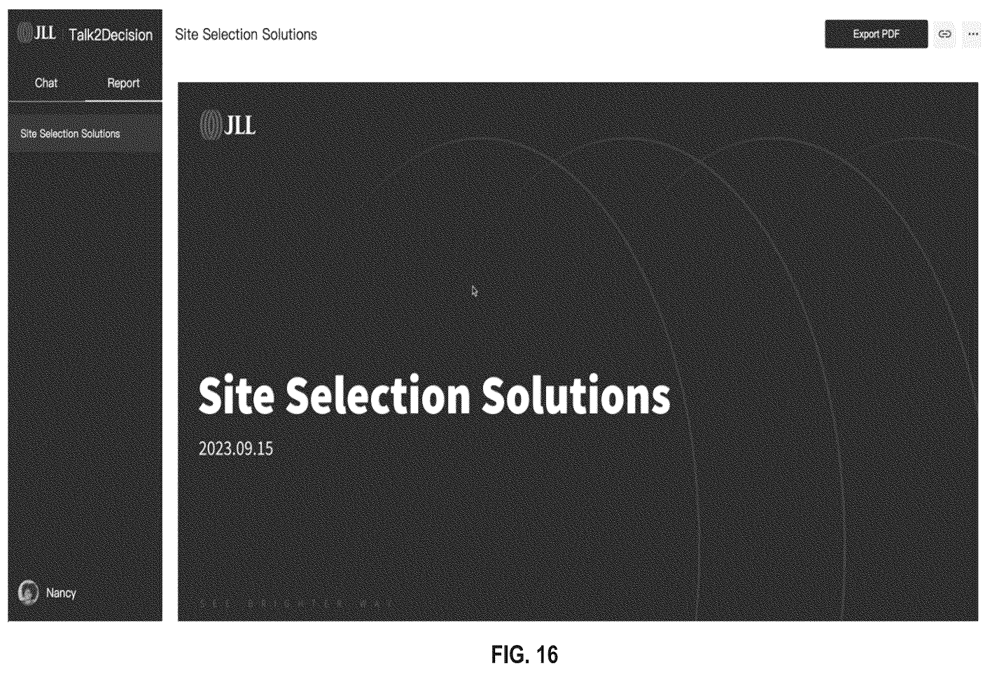

Additionally, the report can be interactive, incorporating interactive visualizations to enhance user engagement and understanding. These visualizations can include interactive maps, radar charts, industry layouts, and customer profiling, among others. Users can interact with these visualizations to explore data dynamically, such as zooming in on specific areas of a map, adjusting parameters on a radar chart, or filtering data in customer profiles. This interactivity allows users to gain deeper insights and make more informed decisions based on the visualized data. Then, the collaborative computing system 12 can modify the graphical user interface to include the interactive report as illustrated in FIG. 16-21. In step 325, the process can terminate.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

What is claimed is:

1. A method comprising:
extracting, by a computing device, key content from a question prompt using key information extraction and lexical analysis, wherein the question prompt is received from a client device;
generating, by the computing device, an enriched question based on the question prompt and relevant node information, wherein the relevant node information is based on relevant graph nodes obtained by matching the key content with nodes in a knowledge graph;
processing, by the computing device, the enriched question with a machine learning model to generate an answer to the question prompt; and
transmitting, by the computing device, the answer to the question prompt received from the machine learning model to the client device.

2. The method as set forth in claim 1, further comprising:
providing, a function invocation response from an API to the machine learning model to integrate data from an internal system as predefined functions.

3. The method as set forth in claim 2, wherein the providing the function invocation response to the machine learning model further comprises:
receiving, from the machine learning model by the computing device, a recommendation for a function invocation with corresponding parameters;
in response to determining the machine learning model recommends the function invocation, providing, by the computing device, the function invocation with the corresponding parameters to the API; and
receiving, from the API by the computing device, a response to the function invocation;
providing, to the machine learning model by the computing device, the enriched question with the response to the function invocation; and
providing, to the client device by the computing device, the answer, wherein the answer received from the machine learning model is determined using the enhanced question and the response to the function invocation.

4. The method as set forth in claim 3, wherein the question prompt further comprises two or more question prompts, and wherein a graphical user interface is generated and transmitted to the client device comprising a chatbot configured to receive the two or more question prompts and provide one or more answers.

5. The method as set forth in claim 4, wherein the graphical user interface comprising the chatbot is generated and provided to one or more users at a respective one or more client devices, and wherein a report is generated to address the two or more question prompts from the one or more users to summarize a best solution to the two or more question prompts.

6. The method as set forth in claim 5, further comprising:
generating and transmitting, by the computing device, the report to one of the one or more client devices, wherein the report is generated by classifying and grouping the two or more question prompts using the knowledge graph, and wherein the one or more answers to the two or more question prompts is enhanced using the knowledge graph based on the grouping of the two or more question prompts.

7. The method as set forth in claim 5, wherein the knowledge graph is generated by extracting key points and relationships between the key points from internal and external resources and wherein the nodes and associations between the nodes in the knowledge graph are generated based on the key points and relationships.

8. A collaborative computing system comprising:
one or more processors;
a memory comprising programmed instructions stored thereon, the one or more processors configured to be capable of executing the stored programmed instructions to:
extract key content from a question prompt using key information extraction and lexical analysis, wherein the question prompt is received from a client device;
generate an enriched question based on the question prompt and relevant node information, wherein the relevant node information is based on relevant graph nodes obtained by matching the key content with nodes in a knowledge graph;
process the enriched question with a machine learning model to generate an answer to the question prompt; and
transmit the answer to the question prompt received from the machine learning model to the client device.

9. The system as set forth in claim 8, wherein the programmed instructions when executed by the one or more processors further causes the one or more processors to:
provide a function invocation response from an API to the machine learning model to integrate data from an internal system as predefined functions.

10. The system as set forth in claim 9, wherein the providing the function invocation response to the machine learning model further comprises:
receiving, from the machine learning model, a recommendation for a function invocation with corresponding parameters;
in response to determining the machine learning model recommends the function invocation, providing the function invocation with the corresponding parameters to the API;
receiving, from the API, a response to the function invocation;
providing, to the machine learning model, the enriched question with the response to the function invocation; and
providing, to the client device, the answer, wherein the answer received from the machine learning model is determined using the enhanced question and the response to the function invocation.

11. The system as set forth in claim 10, wherein the question prompt further comprises two or more question prompts, and wherein a graphical user interface is generated and provided to the client device comprising a chatbot configured to receive the two or more question prompts and provide one or more answers.

12. The system as set forth in claim 11, wherein the graphical user interface comprising the chatbot is generated and provided to one or more users at a respective one or more client devices, and wherein a report is generated to address the two or more question prompts from the one or more users to summarize a best solution to the two or more question prompts.

13. The system as set forth in claim 12, wherein the programmed instructions when executed by the one or more processors further causes the one or more processors to:
generate and transmit the report to one of the one or more client devices, wherein the report is generated by classifying and grouping the two or more question prompts using the knowledge graph, and wherein the one or more answers to the two or more question prompts is enhanced using the knowledge graph based on the grouping of the two or more question prompts.

14. The system as set forth in claim 12, wherein the knowledge graph is generated by extracting key points and relationships between the key points from internal and external resources and wherein the nodes and associations between the nodes in the knowledge graph are generated based on the key points and relationships.

15. A non-transitory computer readable medium having stored thereon instructions comprising executable code which when executed by one or more processors, causes the one or more processors to:
extract key content from a question prompt using key information extraction and lexical analysis, wherein the question prompt is received from a client device;
generate an enriched question based on the question prompt and relevant node information, wherein the relevant node information is based on relevant graph nodes obtained by matching the key content with nodes in a knowledge graph;
process the enriched question with a machine learning model to generate an answer to the question prompt; and
transmit the answer to the question prompt received from the machine learning model to the client device.

16. The non-transitory computer readable medium as set forth in claim 15, wherein the executable code when executed by the one or more processors further causes the one or more processors to:
provide a function invocation response from an API to the machine learning model to integrate data from an internal system as predefined functions.

17. The non-transitory computer readable medium as set forth in claim 16, wherein the providing the function invocation response to the machine learning model further comprises:
receiving, from the machine learning model, a recommendation for a function invocation with corresponding parameters;
in response to determining the machine learning model recommends the function invocation, providing the function invocation with the corresponding parameters to the API;
receiving, from the API, a response to the function invocation;
providing, to the machine learning model, the enriched question with the response to the function invocation; and
providing, to the client device, the answer, wherein the answer received from the machine learning model is determined using the enhanced question and the response to the function invocation.

18. The non-transitory computer readable medium as set forth in claim 17, wherein the question prompt further comprises two or more question prompts, and wherein a graphical user interface is generated and provided to the client device comprising a chatbot configured to receive the two or more question prompts and provide one or more answers.

19. The non-transitory computer readable medium as set forth in claim 18, wherein the graphical user interface comprising the chatbot is generated and provided to one or more users at a respective one or more client devices, and wherein a report is generated to address the two or more question prompts from the one or more users to summarize a best solution to the two or more question prompts.

20. The non-transitory computer readable medium as set forth in claim 19, wherein the knowledge graph is generated by extracting key points and relationships between the key points from internal and external resources and wherein the nodes and associations between the nodes in the knowledge graph are generated based on the key points and relationships.
